(19) United States
(12) Patent Application Publication
(10) Pub. No.: US 2002/0198357 A1
(43) Pub. Date: Dec. 26, 2002

(54) Modified polyaspartic acid

(76) Inventors: Thomas Klein, Koln (DE); Holger Schmidt, Dormagen (DE); Monika Cordes, Leverkusen (DE); Manfred Klutsch, Koln (DE)

Correspondence Address: BAYER CORPORATION, PATENT DEPARTMENT, 100 BAYER ROAD, PITTSBURGH, PA, 15205, US

(21) Appl. No.: 10/105,855

(22) Filed: Mar. 25, 2002

(30) Foreign Application Priority Data
Mar. 28, 2001 (DE) 10115226.4

(51) Int. Cl. C08G 69/10

(52) U.S. Cl. 528/328

(57) ABSTRACT

The present invention relates to a novel process for preparing modified polyaspartic acids starting from C₄ carboxylic acids and nitrogen donor compounds and also aminobenzoic acids, and to the use of these modified polyaspartic acids as optical brighteners.

### BACKGROUND

The present invention relates to a novel process for preparing modified polyaspartic acids starting from C₄ carboxylic acids and nitrogen donor compounds and also aminobenzoic acids, and to the use of these modified polyaspartic acids as optical brighteners.

Disadvantages of conventional brighteners include their lack of biodegradability and, in many cases, the phenomenon known as “spotting.” This refers generally to the preferential attachment of the brightener to strongly colored or otherwise-modified areas of textiles, particularly at low temperature. The result is an inhomogeneous (heterogeneous) distribution of the brightener on the surface, with the resultant nonuniform brightening. A particular characteristic is the development of local areas in which there is a markedly visible accumulation of the optical brightener as compared with the surrounding surface. An increase in the water-solubility of the brightener ought to counter this effect.

With applications of optical brighteners in papermaking as well, the biodegradability of all of the ingredients is of importance, since paper can be disposed of in waste landfills or composted. Moreover, in the manufacture of paper, water plays a critical part, so that here as well an improved brightener solubility is of advantage.

EP-A 0 786 487 discloses a process for preparing polyaspartic acids from ammonium salts of maleic acid, in which the reaction solution prepared from maleic salts is polymerized without the addition of comonomers, at temperatures from 140 to 350° C., to polysuccinimide, which is subsequently hydrolysed in basic medium to polyaspartic salts. The effect of polyaspartic acids as dispersants is known, which is why they are used in DE-A 43 10 503 to disperse optical brighteners in water. The noncopolymerized polyaspartic acids prepared in accordance with EP-A 0 786 487 do not themselves exhibit any optical brightener properties. ET671453235US

JP-A 11 246 374 discloses a teeth brightening composition composed of a copolymer of phosphates and amino acids which is intended to prevent by chemical means the discoloration of dental enamel and so to reduce the proportion of abrasive additives in dental cosmetics. Polyaspartic acids are not designated therein.

Owing to the outstanding biological properties with regard to the breakdown behavior of the polyaspartic acids, the object of the present invention was to modify polyaspartic acids in such a way that they themselves can be used as optical brighteners in aqueous or organic solutions.

U.S. Pat. No. 4,696,981 discloses the incorporation of foreign amino acids in polyaspartic acids which are prepared by polymerization of ammonium salts of maleic acid under the action of microwaves.

DE-A 19 545 678 describes alkyl-modified polyaspartic acids wherein the linking between the alkyl group and the polyaspartic acid backbone is by way of ester groups.

EP-A 0 959 091 describes the reaction of maleic monoamides or ammonium salts of the maleic monoamides to hydrophobicized polyaspartic acid derivatives without the addition of ammonium salts of maleic acid but, if desired, with the addition of amines as copolymers.

The copolymers of polyaspartic acids that are obtainable in accordance with the prior art do predominantly exhibit good biodegradability and improved water-solubilities, but do not themselves display optical brightener properties.

It has now been found, and it is this which provides achievement of the object, that polyaspartic acids which are copolymerized with amino-carboxylic acids, preferably aromatic aminocarboxylic acids, are not only biodegradable, exhibit high dispersing power, but additionally fluoresce in the blue wavelength range but also, furthermore, can be attached uniformly to fibers, so making them suitable for use as optical brighteners.

### SUMMARY

The invention relates to a process for preparing a modified polyaspartic acid comprising: a) reacting an unsaturated C₄ dicarboxylic acid with a first nitrogen donor compound and forming a reaction mixture having at least one low molecular weight reaction product of the unsaturated C₄ dicarboxylic acid and the first nitrogen donor compound; b) transferring the reaction mixture to a continuously operated reactor and adding a second nitrogen donor compound; c) treating the reaction mixture at a temperature ranging from about 120 to about 350° C. and forming a polymer (i) containing repeating succinyl units and aspartamide units, and (ii) having a molecular weight Mw >1300 g/mol; and d) hydrolysing the polymer with an aqueous solution of a basic compound and forming a polymer containing repeating aspartic salt units and aspartamide units.

### DESCRIPTION OF THE FIGURES

These and other features, aspects, and advantages of the present invention will become better understood with reference to the following description and appended claims, where

FIG. 1 shows the wavelength dependency of the fluorescence of pure polyaspartic acid X) and a polyaspartic acid-2-aminobenzoic acid copolymer Y) containing 2.1 mol % copolymerized 2-aminobenzoic acid. It can be seen that the fluorescence maxima of the polyaspartic acid and of the copolymer are situated at virtually identical wavelengths, and

FIG. 2 shows the fluorescence at the same intensity of excitation of copolymers containing

a) 2.5 mol % 2-aminobenzoic acid

b) 5 mol % 2-aminobenzoic acid

c) 10 mol % 2-aminobenzoic acid

in comparison to X) pure polyaspartic acid.

### DESCRIPTION

The present invention therefore provides a process for preparing modified polyaspartic acids, characterized in that

a) an unsaturated C₄ dicarboxylic acid A is reacted with a nitrogen donor compound B to give a reaction mixture, with at least one low molecular weight reaction product of A and B, preferably having a molecular weight Mw that is less than about 1300 g/mol (<1300 g/mol),

b) the reaction mixture is then transferred to a continuously operated reactor with the addition of a further nitrogen donor compound, C,

c) the reaction mixture is treated at a temperature ranging from about 120 to about 350° C. to give a polymer containing repeating succinyl units and aspartamide units, having a molecular weight Mw >1300 g/mol (more than about 1300 g/mol), and

d) the resulting polymer is hydrolysed with an aqueous solution of a basic compound D to give a polymer containing repeating aspartic salt units and aspartamide units.

Examples of suitable C₄ dicarboxylic acids A for the purposes of the present invention in process step a) are maleic anhydride, maleic acid or fumaric acid, individually or in a mixture with one another.

Suitable nitrogens donor compounds B for the purposes of the present invention are ammonia or ammonia-releasing compounds, especially ammonium salts and amides of carbonic acid such as ammonium hydrogen carbonate, diammonium carbonate, urea, ammonium cyanate, carbamic acid or ammonium carbamide. Similarly, it is also possible to use other organic and inorganic ammonium salts. These precursors may be used individually or in mixtures in the absence of solvent or in solution. Where ammonia is used as precursor B, it may also be used in gaseous form.

The preparation of the reaction mixtures in process step a) takes place preferably either by reacting maleic anhydride with ammonia or ammonia derivatives or by reacting maleic anhydride first with water to maleic acid and then reacting the acid with ammonia or ammonia derivatives. In one particularly preferred embodiment, maleic anhydride is reacted with ammonia or ammonia derivatives.

The first reaction step a) is a strongly exothermic reaction. The heat produced must be dissipated by efficient cooling of the reaction vessel. As reaction conditions, temperatures are to be chosen preferably between about 60 and about 250° C., in particular from about 70 to about 170° C. and with particular preference from about 80 to about 150° C. The residence times may vary between about 1 min and about 20 hours; preferably, they are from about 2 min to about 3 hours. The pressures are established specifically as a function of the reaction regime and/or the temperature.

For carrying out the first process step a), particularly suitable reactors are those which permit effective regulation of the reaction conditions. The first reaction step is preferably conducted in a discontinuous stirred tank.

The reaction mixture produced in the first process step, a), is polymerized thermally in the second process step, b), with the addition of a component C. Component C may be added as a solid, by way of a conveying means, or as a melt, by way of a metering pump, to the reaction mixture. Particularly suitable components C (comonomers) for incorporation into polyaspartic acids are aminocarboxylic acids. For the purposes of the present invention, preference is given to using aromatic amino-carboxylic acids whose aromatic group is composed of monocyclic or polycyclic systems with or without heteroatoms. Furthermore, the aromatic radical may carry additional acidic groups such as sulfonic acid groups or phosphonic acid groups. With particular preference, 2-aminobenzoic acid is suitable for addition to the monomer composition. The comonomer may be added in fractions of from about 0.01 to about 75 mol % of the reaction mixture.

Subsequently, in process step c), the resulting mixture of step b) is passed into the polymerization reactor. Suitable apparatus for the polymerization includes preferably apparatus which provides, with a narrow residence time distribution of the viscous-liquid phase, the necessary minimum residence time for polymerization, the necessary temperature regime, and at the same time an at least partial evaporation of the solvent, particularly of the water, and also of the water formed in the reaction. Preferred apparatus of this kind may include, for example,

delay tubes

high-viscosity reactors, as described in EP-A 0 612 784 A1, for example

dryers as described in DE-A-4 425 952, for example

stirred tank cascade

thin-film evaporators

multiphase helical tube reactors

which may be employed individually or in combination with one another.

Where the reaction mixture passes in succession through a combination of two reactors for the polymerization, component C may be metered in upstream of the first reactor, upstream of the second reactor, or else upstream of both reactors.

The removal or supply of heat from or to the reactor is controlled in such a way that, depending on the nature and concentration of the substances used, the second reaction step takes place at from about 120 to about 350° C., preferably at from about 140 to about 300° C., and, with particular preference, at from about 140 to about 270° C. The residence times in the reactor system to be used for process step c) are up to about 120 minutes; residence times of up to about 30 minutes are preferred. The residence time is preferably chosen so that polymerization is substantially complete. Depending on their water and/or solvent content, the reaction products obtained are solutions, melts or solids.

Finally, in process step d), the polymers thus obtained are reacted with an aqueous alkaline solution, in a reaction in which all or some of the succinimide units present in the polymer are converted into aspartate units. Preference is given to using an aqueous solution of ammonia or of alkali metal or alkaline earth metal oxides or hydroxides, with particular preference aqueous ammonia solution or sodium or potassium hydroxide solution.

To this reaction, a solution of ammonia or of an alkali metal or alkaline earth metal hydroxide in water is charged to a reaction vessel with stirrer means, and the polymer from process step c) is introduced into this vessel. The amount of alkali may be equimolar in relation to the succinyl units in the polymer introduced, or may represent a subequimolar amount. In the second case, the resulting polyaspartate includes succinimide units which are still unchanged. The residence time of the hydrolysis mixture in the vessel is between about 10 minutes and about 24 hours, preferably between about 30 minutes and about 12 hours. The reaction takes place at temperatures between about 50 and about 150° C., preferably between about 60 and about 140° C.

The present invention therefore additionally provides modified polyaspartic acids obtainable by

a) reacting an unsaturated C₄ dicarboxylic acid A with a nitrogen donor compound B to give a reaction mixture comprising at least one low molecular weight reaction product of A and B, preferably having a molecular weight Mw<1300 g/mol,

b) transferring the reaction mixture to a continuously operated reactor with the addition of a further nitrogen donor compound C,

c) treating the reaction mixture at a temperature from about 120 to about 350° C. to give a polymer containing repeating succinyl units and aspartamide units, having a molecular weight Mw>1300 g/mol, and

d) hydrolysing the resulting polymer with an aqueous solution of a basic compound D to give a polymer containing repeating aspartic salt units and aspartamide units.

Where 2-aminobenzoic acid is a comonomer, the process of the invention leads to copolymers having the exemplary formula (I) in diagram 1.

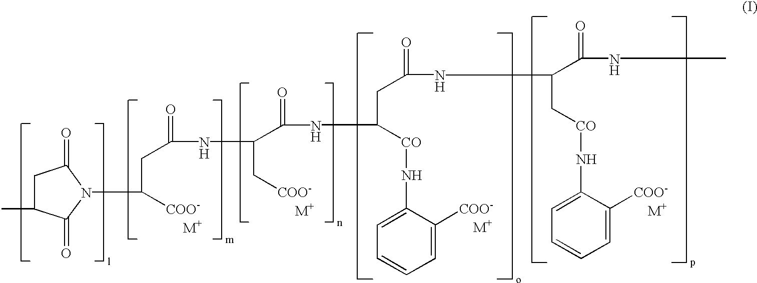

Diagram 1: Exemplary structure of a PAS P-based brightener

In the formula (I)

M stands for an alkali metal or alkaline earth metal, preferably lithium, sodium, potassium, magnesium, calcium, strontium or barium, and

l, m, n, o and p each independently of one another stand for from 0.001 to 0.996 molar fractions of all the polymer units, the sum of l+m+n+o+p being=1.

The linking of the aminobenzoic acid units to the polymer main chain by way of amide bonds is retained during the basic hydrolysis of the succinimide units. Polymerization and hydrolysis may be operated either batchwise or continuously. Following basic hydrolysis of the succinimide units in the polymer, the resulting solution may be lightened in color by adding hydrogen peroxide.

The modified polyaspartic acids obtainable in accordance with the process of the invention surprisingly exhibit fluorescence, which makes it possible to use them as optical brighteners.

The invention therefore also provides for the use of the modified polyaspartic acid prepared in accordance with the process described above as an optical brightener in textiles, paper, paints, coating films, plastics, dental enamel, etc.

They may be used in the production, processing, cleaning or care of textiles, paper, paints, coating films, plastics or teeth.

As textiles for the purposes of the present invention, mention may be made, by way of example, of cotton, viscose, wool, polyester, polyamide, polyacrylonitrile or polypropylene fibers.

The present invention therefore also provides compositions for textile production and textile care, papermaking, care of paints or coatings, plastics production and plastics care, and also dental care, characterized in that these compositions comprise an optically brightening fraction of modified polyaspartic acids prepared by the process of the invention. In one embodiment, the invention relates to a method for treating a substrate comprising treating the substrate with a modified polyaspartic acid prepared in accordance with the invention. Preferred substrates textile substrates, paper substrates, paint substrates, coating film substrates, plastic substrates and teeth substrates.

With particular preference, the present invention provides laundry detergents, coating care compositions, cosmetics or dental care compositions containing from about 1 to about 50,000 ppm, preferably from 10 to 5,000 ppm, with particular preference from about 100 to 1,000 ppm, of modified polyaspartic acid obtainable by the process of the invention.

The invention is further described in the following illustrative examples in which all parts and percentages are by weight unless otherwise indicated.

### EXAMPLES

Examples of the Preparation of Modified Polyaspartic Acid

### Example 1

415.7 g of ammonium maleate and 20.7 g of 2-aminobenzoic acid were melted at 180° C. in a high-viscosity reactor and kneaded. After 30 to 45 minutes, the viscosity of the melt rose until a solid mass was produced. The solid was dissolved in sodium hydroxide solution, forming a sodium poly(aspartate-co-aminobenzoate) whose fluorescence activity was greater than that of a product without comonomer content. The fluorescence was measured using a commercially available fluorospectrometer, e.g., the spectrometer AB 2 from Polytec, Waldbronn.

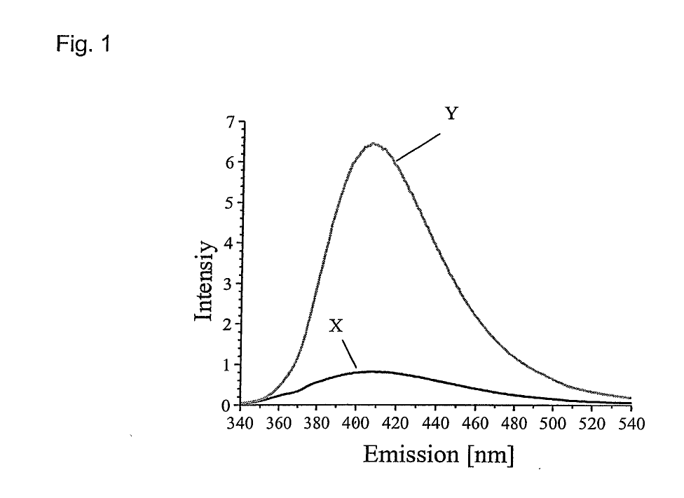

As discussed above, FIG. 1 shows the wavelength dependency of

the fluorescence of pure polyaspartic acid X) and a polyaspartic acid-2-aminobenzoic acid copolymer Y) containing 2.1 mol % copolymerized 2-aminobenzoic acid. It can be seen that the fluorescence maxima of the polyaspartic acid and of the copolymer are situated at virtually identical wavelengths.

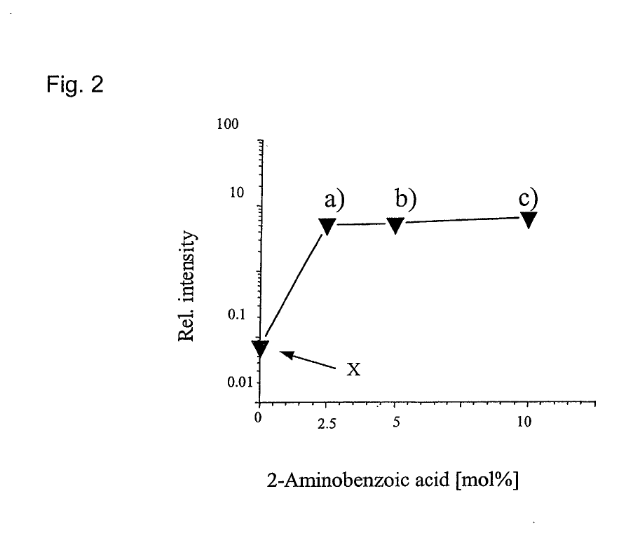

FIG. 2 shows the fluorescence at the same intensity of excitation of copolymers containing

a) 2.5 mol % 2-aminobenzoic acid

b) 5 mol % 2-aminobenzoic acid

c) 10 mol % 2-aminobenzoic acid

in comparison to

X) pure polyaspartic acid.

The intensity of the fluorescence of the copolymers exceeds that of the pure polyaspartic acid by more than 80 times (see lower diagram, y-axis logarithmic).

Each measurement was made on aqueous solutions containing 50 ppm optical brightener or polyaspartic acid. The graph shows the entirely surprising effect of the fluorescent properties of modified polyaspartic acids containing copolymerized aminocarboxylic acid comonomer.

### Example 2

Reaction mixture according to Example 1, the mixture was melted at 180° C. in an unstirred vessel. The mass solidified with foaming. The material was again dissolved in sodium hydroxide solution.

Examples of improving the whiteness were observed.

### Example 3

A fabric sample “BP 1” was digested for 30 min at 40° C. in an inventive aqueous PASP solution, w(PASP)=0.5%. The composition was then stirred in DI water for 10 min and dried overnight (DI water=deionized water).

Between the original and the treated material, there was a brightening by 1.8, as indicated in Table 1.

TABLE 1

| | Whiteness with filter | Without filter | Brightening |
|---|---|---|---|
| with PASP | 70.7 | 144.0 | 73.3 |
| untreated | 68.5 | 140.0 | 71.5 |

UV filter. The CIE whiteness was used.

### Example 4

Using standard fabrics (polyacrylonitrile, polyester, polyamide and cotton), the experiments were repeated under the same conditions as in Example 3.

Distinct brightenings were found, as indicated in Tables 2-5.

Cotton

TABLE 2

| | Whiteness with filter | Without filter | Brightening |
|---|---|---|---|
| untreated | 67.7 | 67.9 | 0.2 |
| with PASP + | 69.4 | 70.1 | 0.7 |
| rinsed | | | |
| with DI water | 68.6 | 68.9 | 0.3 |

Polyacrylonitrile

TABLE 3

| | Whiteness with filter | Without filter | Brightening |
|---|---|---|---|
| untreated | 36.9 | 37.1 | 0.2 |
| with RASP + | 35.7 | 38.9 | 3.2 |
| with DI water | 36.9 | 37.3 | 0.4 |

Polyester

TABLE 4

| | Whiteness with filter | Without filter | Brightening |
|---|---|---|---|
| untreated | 64 | 64.1 | 0.1 |
| with PASP + | 65.1 | 66.9 | 1.8 |
| rinsed | | | |
| with DI water | 64.2 | 64.4 | 0.2 |

Polyamide

TABLE 5

| | Whiteness with filter | Without filter | Brightening |
|---|---|---|---|
| untreated | 63 | 63.2 | 0.2 |
| with PASP + | 62.9 | 63.5 | 0.5 |
| rinsed | | | |
| with DI water | 61.7 | 62.0 | 0.3 |

### Example 5

Test conditions:

Tests were conducted using the following substances: PASP and inventive PASP copolymer.

In each case, five solutions per substance were prepared, with different active substance fractions. Each solution had a constant sodium sulfate fraction of 3 g per liter.

These solutions were applied to cotton poplin using a roller apparatus, followed by drying at 100° C. for 30 s. Thereafter, the whiteness was measured.

All pieces of fabric exhibit distinct brightening, as shown in Tables 6, 7, 8, and 9.

Cotton Poplin and PASP

TABLE 6

| | Whiteness with filter | Without filter | Brightening |
|---|---|---|---|
| untreated | 77.9 | 78.2 | 0.3 |
| 856 ppm | 77.9 | 79.9 | 2.0 |
| 1712 ppm | 77.3 | 79.3 | 2.1 |
| 2568 ppm | 77.3 | 78.2 | 2.0 |
| 4280 ppm | 76.3 | 77.5 | 2.4 |
| 6420 ppm | 72.4 | 74.9 | 2.6 |

Cotton Poplin and PASP Copolymer

TABLE 7

| | Whiteness with filter | Without filter | Brightening |
|---|---|---|---|
| untreated | 77.9 | 78.1 | 0.2 |
| 440 ppm | 78.1 | 80.3 | 2.2 |
| 880 ppm | 77.0 | 79.4 | 2.3 |
| 1320 ppm | 76.6 | 79.6 | 3.0 |
| 2200 ppm | 75.0 | 78.2 | 3.2 |
| 3300 ppm | 74.2 | 77.9 | 3.7 |

Cotton Poplin and PASP

TABLE 8

| | Whiteness with filter | Without filter | Brightening |
|---|---|---|---|
| untreated | 77.9 | 78.1 | 0.2 |
| 100 ppm | 78.9 | 80.6 | 1.7 |
| 200 ppm | 78.8 | 80.4 | 1.6 |
| 300 ppm | 78.8 | 80.4 | 1.6 |
| 500 ppm | 78.6 | 80.3 | 1.7 |
| 750 ppm | 78.6 | 80.4 | 1.8 |

Cotton Poplin and PASP Copolymer

TABLE 9

| | Whiteness with filter | Without filter | Brightening |
|---|---|---|---|
| untreated | 78.0 | 78.1 | 0.1 |
| 100 ppm | 79.0 | 80.6 | 1.6 |
| 200 ppm | 78.9 | 80.7 | 1.9 |
| 300 ppm | 78.6 | 80.4 | 1.8 |
| 500 ppm | 78.4 | 80.7 | 2.3 |
| 750 ppm | 77.6 | 80.0 | 2.4 |

Although the present invention has been described in detail with reference to certain preferred versions thereof, other variations are possible. Therefore, the spirit and scope of the appended claims should not be limited to the description of the versions contained therein.

What is claimed is:

1. A process for preparing a modified polyaspartic acid comprising:
a) reacting an unsaturated C₄ dicarboxylic acid with a first nitrogen donor compound and forming a reaction mixture having at least one low molecular weight reaction product of the unsaturated C₄ dicarboxylic acid and the first nitrogen donor compound;
b) transferring the reaction mixture to a continuously operated reactor and adding a second nitrogen donor compound;
c) treating the reaction mixture at a temperature ranging from about 120 to about 350° C. and forming a polymer (i) containing repeating succinyl units and aspartamide units, and (ii) having a molecular weight Mw>1300 g/mol; and
d) hydrolysing the polymer with an aqueous solution of a basic compound and forming a polymer containing repeating aspartic salt units and aspartamide units.

2. The process according to claim 1, wherein the unsaturated C₄ dicarboxylic acid is selected from the group consisting of maleic anhydride, maleic acid, fumaric acid, and mixtures thereof.

3. The process according to claim 1, wherein the first nitrogen donor compound is selected from the group consisting of ammonia, ammonia-releasing compounds, ammonium salts, and amides of carbonic acid.

4. The process according to claim 1, wherein in step a), the reaction product of the unsaturated C₄ dicarboxylic acid and the first nitrogen donor compound has a molecular weight Mw<1300 g/mol.

5. The process according to claim 1, wherein in step b), the second nitrogen donor compound is an aminocarboxylic acid.

6. The process according to claim 1, wherein in step d), the basic compound is an aqueous solution of ammonia or alkali metal or alkaline earth metal oxides or alkali metal or alkaline earth metal hydroxides.

7. The process according to claim 1, wherein the process produces a polyaspartic acid-based brightener having the formula (I): 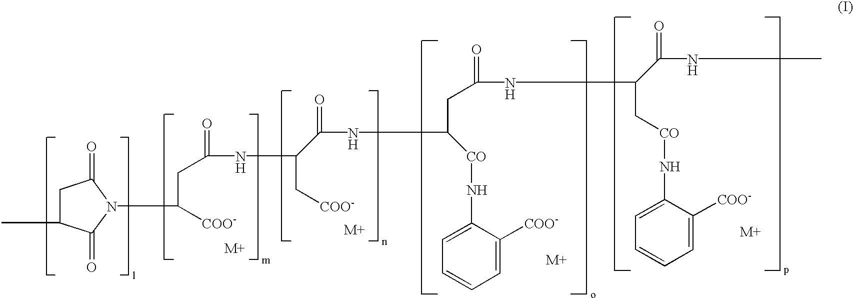
wherein
M is an alkali metal or alkaline earth metal, and
l, m, n, o and p each independently of one another is from 0.001 to 0.996 molar fractions of all the polymer units, wherein the sum of l+m+n+o+p is 1.

8. A modified polyaspartic acid prepared by:
a) reacting an unsaturated C₄ dicarboxylic acid with a first nitrogen donor compound and forming a reaction mixture having at least one low molecular weight reaction product of the unsaturated C₄ dicarboxylic acid and the first nitrogen donor compound;
b) transferring the reaction mixture to a continuously operated reactor and adding a second nitrogen donor compound;
c) treating the reaction mixture at a temperature ranging from about 120 to about 350° C. and forming a polymer (i) containing repeating succinyl units and aspartamide units, and (ii) having a molecular weight Mw>1300 g/mol; and
d) hydrolysing the polymer with an aqueous solution of a basic compound and forming a polymer containing repeating aspartic salt units and aspartamide units, and thereby forming the modified polyaspartic acid.

9. The modified polyaspartic acid according to claim 8, wherein the modified polyaspartic acid is an optical brightener.

10. The modified polyaspartic acid according to claim 8, wherein the modified polyaspartic acid is a brightener having the formula (I): 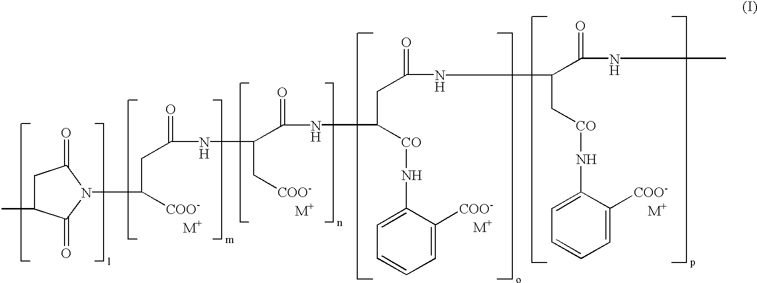
wherein
M is an alkali metal or alkaline earth metal, and
l, m, n, o and p each independently of one another is from 0.001 to 0.996 molar fractions of all the polymer units, wherein the sum of l+m+n+o+p is 1.

11. A composition comprising a modified polyaspartic acid in an amount ranging from about 1 to about 50,000 ppm, wherein the modified polyaspartic acid is an optical brightener and the composition is selected from the group consisting of laundry detergent compositions, coating care compositions, cosmetic compositions and dental care compositions, and wherein the modified polyaspartic acid is made by
a) reacting an unsaturated C₄ dicarboxylic acid with a first nitrogen donor compound and forming a reaction mixture having at least one low molecular weight reaction product of the unsaturated C₄ dicarboxylic acid and the first nitrogen donor compound;
b) transferring the reaction mixture to a continuously operated reactor and adding a second nitrogen donor compound;
c) treating the reaction mixture at a temperature ranging from about 120 to about 350° C. and forming a polymer (i) containing repeating succinyl units and aspartamide units, and (ii) having a molecular weight Mw>1300 g/mol; and
d) hydrolysing the polymer with an aqueous solution of a basic compound and forming a polymer containing repeating aspartic salt units and aspartamide units, and thereby forming the modified polyaspartic acid.

12. An optical brightener comprising a polymer containing repeating aspartic salt units and aspartamide units.

13. The optical brightener according to claim 12, wherein the brightener has the formula (I): 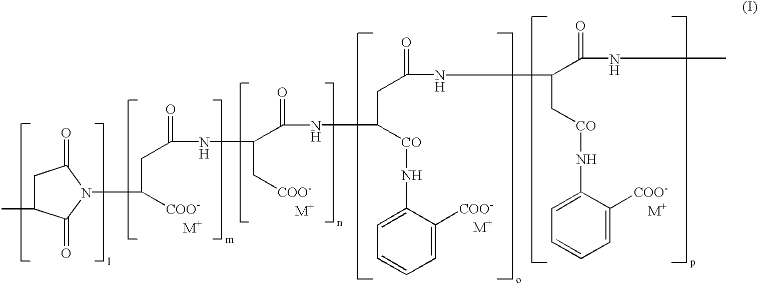
wherein
M is an alkali metal or alkaline earth metal, and
l, m, n, o and p each independently of one another is from 0.001 to 0.996 molar fractions of all the polymer units, wherein the sum of l+m+n+o+p is 1.

14. A method for treating a substrate comprising treating the substrate with a modified polyaspartic acid prepared by:
a) reacting an unsaturated C₄ dicarboxylic acid with a first nitrogen donor compound and forming a reaction mixture having at least one low molecular weight reaction product of the unsaturated C₄ dicarboxylic acid and the first nitrogen donor compound;
b) transferring the reaction mixture to a continuously operated reactor and adding a second nitrogen donor compound;
c) treating the reaction mixture at a temperature ranging from about 120 to about 350° C. and forming a polymer (i) containing repeating succinyl units and aspartamide units, and (ii) having a molecular weight Mw>1300 g/mol; and
d) hydrolysing the polymer with an aqueous solution of a basic compound and forming a polymer containing repeating aspartic salt units and aspartamide units, and thereby forming the modified polyaspartic acid.

15. The method according to claim 14, wherein the substrate is selected from the group consisting of textile substrates, paper substrates, paint substrates, coating film substrates, plastic substrates and teeth substrates.
